(19) United States
(12) Patent Application Publication
(10) Pub. No.: US 2022/0111408 A1
(43) Pub. Date: Apr. 14, 2022

(54) Surface cleaner with multiple uses

(71) Applicant: Mosmatic AG, Necker (CH)

(72) Inventor: Patrick RIEBEN, Necker (CH)

(21) Appl. No.: 17/498,989

(22) Filed: Oct. 12, 2021

(30) Foreign Application Priority Data
Oct. 13, 2020 (DE) 10 2020 126790.8

(51) Int. Cl. B05B 9/00; A47L 13/26; B08B 3/02; B05B 12/36

(52) U.S. Cl. CPC B05B 9/007; A47L 13/26; B60S 3/04; B05B 12/36; B08B 3/026

(57) ABSTRACT

A surface cleaner with a connection to a high-pressure medium, consisting of a pot- shaped housing (11) open on one side, in which at least one rotor arm (6) is rotatably mounted on a swivel joint (5) in the center of the housing, wherein one or more cleaning nozzles (27) are arranged on the rotor arm (6), which are connected in a fluid-conducting manner to the high-pressure medium guided through the swivel joint (5), wherein the housing (11) is designed to be able to turn 180 degrees for a second operating mode, wherein the surface cleaner can be operated in the at least two different operating modes, wherein the first operating mode consists of a surface cleaning operation with the housing (11) and the cleaning nozzles (27) arranged therein pointing downwards toward a floor, and wherein the second operating mode is designed as a cleaning operation in which the housing (11), turned over 180 degrees with the cleaning nozzles (27) pointing upwards, is directed toward a cleaning surface arranged at a distance from the floor, characterized in that the surface cleaner has a chassis (8, 9, 17) for supporting the housing (11) in the first and second operating positions relative to the floor surface.

The invention relates to a surface cleaner with multiple uses, according to the preamble of claim 1.

Surface cleaners are known from the subject matter of DE 20 2009 005 636 U1 and DE 100 66 009 B4. These are characterized in that a rotor arm is driven to rotate in the interior of an approximately cylindrical housing due to the action of a high-pressure medium, executing a cleaning of the cleaning surface with its spray nozzles which are directed at an angle toward the cleaning surface on the floor.

Such a surface cleaning head with surface cleaning arrangements has also been disclosed, by way of example, via the subject matter of DE 10 2010 003 079 A1.

However, the disadvantage of the known arrangements is that there is no option for multiple uses. The term “multiple uses” is understood to mean that the surface cleaner can be used not only for cleaning floor surfaces, but also for cleaning approximately horizontal surfaces which are opposite the floor surfaces at a distance therefrom, such as, for example, the underbody surfaces of motor vehicles, or other surfaces to be cleaned.

U.S. Pat. No. 5,991,968 A discloses, in FIGS. 32 to 37, a surface cleaner with multiple uses, which enables at least two different cleaning modes, One cleaning mode is used to clean floor surfaces, while the second cleaning mode is used to clean wall and/or ceiling surfaces. The disclosed surface cleaner consists of 2 different chassis, wherein the first chassis is a lifting frame with castors supported on the floor; the surface cleaner can be raised and lowered in two opposite horizontal swivel joints with its second chassis, and is arranged in the lifting frame of the first chassis in a manner allowing turning by 180°. The disadvantage of this is that surfaces located one above the other at a small distance cannot be cleaned, due to the size of the surface cleaner. For example, it is not possible with such a surface cleaner to dean a floor in the first operating mode, and to dean a cleaning surface lying close above the floor in the second operating mode—in particular, for example, an underbody of a motor vehicle, wherein the approach provides for a support of the housing on a floor region.

WO212007032 A1 discloses a cleaning device for cleaning the underside of a vehicle, having a cleaning head that can direct at least one pressurized cleaning fluid against the underside of a vehicle, and having a housing that can be moved by means of bottom rollers along a floor surface under the vehicle to be cleaned. The cleaning head can be swiveled relative to the chassis via a swivel mechanism. However, there is no option for a 180-degree turn.

The invention is therefore based on the object of developing a surface cleaner of the type mentioned at the outset in such a way that it achieves these described multiple uses.

To achieve this object, the invention is characterized by the technical teaching of independent claim 1 or 4.

A preferred feature of the invention is that the approximately pot-shaped and cylindrical housing containing the rotor arm is designed to be able to turn 180°.

The term “able to turn through 180°” means that the surface cleaner, in normal operation with its downward-facing housing, which is preferably sealed against the surface to be cleaned with a brush ring, can turn 180°—which means that the housing can be turned completely 180°, such that the rotor arm or arms arranged in the housing, with the spray nozzles arranged thereon, point upwards toward an upper, approximately horizontal surface to be cleaned.

This means that the surface cleaner can be operated in at least two different operating modes, the first operating mode consisting of a surface cleaning operation with cleaning nozzles pointing downwards toward a floor, and the second operating mode being designed as an underbody cleaning operation in which the housing, turned 180 degrees, is directed toward a cleaning surface which faces the floor at a distance therefrom. In the case of underbody cleaning, this cleaning surface is then approximately parallel to the floor surface.

According to the teaching of claim 1, it is preferred if the surface cleaner has a single chassis for supporting the housing in the first and second operating position relative to the floor surface. With little manufacturing and maintenance expenditure, this enables a single chassis to be used for both operating modes, because it can be converted and turned over for each of the operating modes.

However, the invention is not restricted to this. It can also be provided that the chassis, for cleaning floor surfaces, consists of castors which cannot turn over, and the further chassis for the other operating mode also consists of further castors and/or sliding elements which cannot turn over.

In all designs, there is the advantage that cleaning surfaces on the floor side can be treated, and also surfaces opposite the floor, at a distance therefrom, can be treated. Such surfaces are, for example, the undersides of motor vehicles or the like. For example, a surface cleaner which can turn over can also be used to clean the inside and outside filter surfaces of horizontal plate filters, and other devices having a similar geometry.

For all cleaning tasks, it is preferred if the surface cleaner has as low a constructed height as possible, in order to be able to clean surfaces that are close together and opposite each other.

With the given technical teaching, there is also the advantage that the high-pressure connection, with a push rod attached thereto, does not have to be turned over, because when the housing is turned 180°, the high-pressure inlet can remain in place without any need to turn it over, In a preferred manner, the high-pressure inlet is embodied in the form of an articulation joint which is designed to be swivelable at least through an angle of 180°, or less.

In order to enable the housing to be turned 180° from one flat side to the opposite flat side, a further development of the invention provides that the articulation joint, which establishes the high-pressure connection to a high-pressure gun and a lance connected to it, is arranged outside of the circumferential circle of the housing, so as to enable the housing to be turned without colliding with the high-pressure connection on the articulation joint.

The high-pressure medium is also not introduced from above into the swivel joint in the center of the housing, as is known in the prior art, but rather from the side, which further reduces the constructed height of the device.

Until now, it was common to place the articulation joint in the center of the housing, specifically where the swivel joint for the rotor arms attaches. This, however, prevented the housing from being turned by 180°.

The invention proceeds from this point, recognizing that the housing can only be turned by 180° if the high-pressure inlet is made in an articulation joint attached to the side of the housing, in order to make the housing itself able to turn by 180°. The high-pressure connection then does not have to be repositioned when the housing is turned and does not require any additional, avoidable constructed height.

In addition to the above-mentioned measures for turning the housing, further measures are preferably provided in order to also adapt the housing chassis to the ability of the housing to turn.

In a preferred first embodiment of the invention, it is provided that the chassis fulfills a double function, supporting the housing both in the first working position (cleaning the floor) and in the other cleaning position (e.g., underbody cleaning) on the floor surface, and enabling a rolling or sliding function. This is the subject matter of independent claims 1 and 4, and the related dependent claims.

For this purpose, it is provided in a first embodiment that the chassis in a preferred embodiment essentially consists of castors attached to the housing, wherein the castors are swiveled 180° when changing from one operating mode to the other, and then are locked again on the housing in order to enable the housing to be moved on the floor surface even during underbody operation.

It is advantageous if the housing with the chassis (namely the castors which can swivel 180 degrees) has a low constructed height in order to enable the underbody to be cleaned expediently, even when there is little floor clearance for underbodies or other cleaning surfaces to be cleaned.

In a second embodiment of the invention, however, it can also be provided that the cleaning operation in the first type of surface cleaning, with an open housing oriented downward, does not work with the castors, but rather the castors are only provided for the underbody cleaning operating mode, while in the other operating mode (surface cleaning), the housing is simply pushed on the circumferential brush ring of the housing over a surface to be cleaned. In this case, the castors are not designed to be rotatable or swivelable by 180 degrees in their vertical swivel axis, but rather are fixed to the housing and only support the housing in the underbody cleaning mode. In contrast, the castors have no load-bearing function in the floor cleaning mode. With this configuration of the chassis, the constructed height of the surface cleaner can be reduced even further.

In a third embodiment, the chassis can also be completely omitted, such that the housing is supported on a floor surface in both operating modes only by means of sliding elements on the two opposite flat sides of the housing.

Such an elimination of the chassis also enables vertical operation of the surface cleaner, which is then used, for example, when the surface cleaner is inserted in the space between opposing and parallel cleaning surfaces in a vertical plane—e.g., the filter surfaces of a plate filter. The surface cleaner is then only turned by 90 degrees from its floor-side cleaning position in order to also execute this cleaning task of vertically aligned cleaning surfaces.

This means that it is preferred that the castors swivel on the housing side, and this is preferred for ease of use.

In a further development of the first-mentioned embodiment, to improve the ease of use, it is provided that each castor forms a swivel unit, which essentially consists of the castor itself, which is pivotably mounted on a vertical swivel axis at one end of a horizontal angle traverse, the other end of the angle traverse being bent by 90 degrees and received in a horizontal swivel axis by a swivel joint on the housing. Each of the swivel positions is locked by a spring-loaded locking pin. For this purpose, the swivel joint with its swivel shaft is received in a locking housing on the housing on the outer circumference of the surface cleaner. The locking pin is spring- loaded and slidably mounted in the locking housing on the housing, and the bolt- side end of the locking pin engages, spring-loaded, in a locking groove on the swivel shaft of the swivel joint, such that the swivel joint can be swiveled 180° by pulling the locking pin against a spring force.

The locking housing is arranged on the outer circumference of the housing of the surface cleaner. There are preferably three or more castors with associated locking housings fixed to the housing, which are evenly distributed and fastened over the outer circumference of the surface cleaner.

Instead of a chassis with castors that can be individually swiveled by 180° and locked in the respective swivel positions, other chassis constructions can also be used, such as sliding elements, runners, spherical elements, and the like.

In a further development of the invention, it is also provided that the push rod for moving the surface cleaner by hand is designed as a high-pressure gun, which means that a high-pressure gun with an actuating handle is connected directly to an upper lance part via a screw connection, and this upper lance part is screwed via a quick screw connection to a lower lance part, which lower lance part opens into the articulation joint according to the invention. The push rod required for the manual movement of the surface cleaner is accordingly formed by a high-pressure gun with a high-pressure lance attached to it,

Only by relocating the articulation joint laterally and radially outwards from the outer circumference of the surface cleaning housing is it possible for the housing to turn 180°, or less. For this purpose, it is provided that a fluid-conducting connecting tube is attached to the side of the outer circumference of the housing at the articulation joint, which connecting tube guides the high-pressure medium into the central region of the housing and to a swivel joint for driving the rotor arm. The connecting tube is arranged parallel to the cover surface of the housing, and advantageously does not protrude beyond the central swivel joint on the housing side.

When operating in the two operating modes, it has been found that the swivel joint required for mounting the rotor arm must absorb axial forces in directions opposite to each other by 180°. For this purpose, it is provided in an advantageous manner to use a specially designed swivel joint which can absorb the incoming axial forces in mutually opposite directions under the action of the high pressures of up to 300 bar and the high speeds of the rotor arm.

According to a further development of the concept of the invention, it is provided that during underbody operation, in which the housing, open on one side, is directed upwards, a protective plate is arranged in the central region in order to prevent objects from the surface being cleaned from falling into the interior of the housing that is open at the top.

With its reduced diameter, the protective plate is designed in such a way that there is still enough space on the outer circumference for the cleaning nozzles to circulate.

The articulation joint allows the high-pressure gun and the lance connected to it to be tilted to a suitable height on a horizontal swivel axis during operation of the surface cleaner. Furthermore, outlet openings are provided in the cover region of the housing—preferably around the central swivel joint—so that during underbody operation, it is ensured that the dirty water in the interior of the housing, which is open at the top, can flow downwards and outwards through these outlet openings. The aforementioned protective plate also serves to prevent an operator's hand from reaching into the interior of the housing during underbody operation.

The subject matter of the present invention results not only from the subject matter of the individual claims, but also from the combination of the individual claims with each other.

All information and features disclosed in the documents, including the abstract, in particular the spatial configuration shown in the drawings, could be claimed to be substantial to the invention insofar as they are novel over the prior art, individually or in combination. The use of the terms “substantial” or “according to the invention,” or “substantial to the invention” is subjective and does not imply that the features named in this way must necessarily be part of one or more claims.

In the following, the invention is explained in more detail with the aid of the drawings, which show only one embodiment. Further features and advantages of the invention that are substantial to the invention are clear from the drawings and its description.

IN THE DRAWINGS

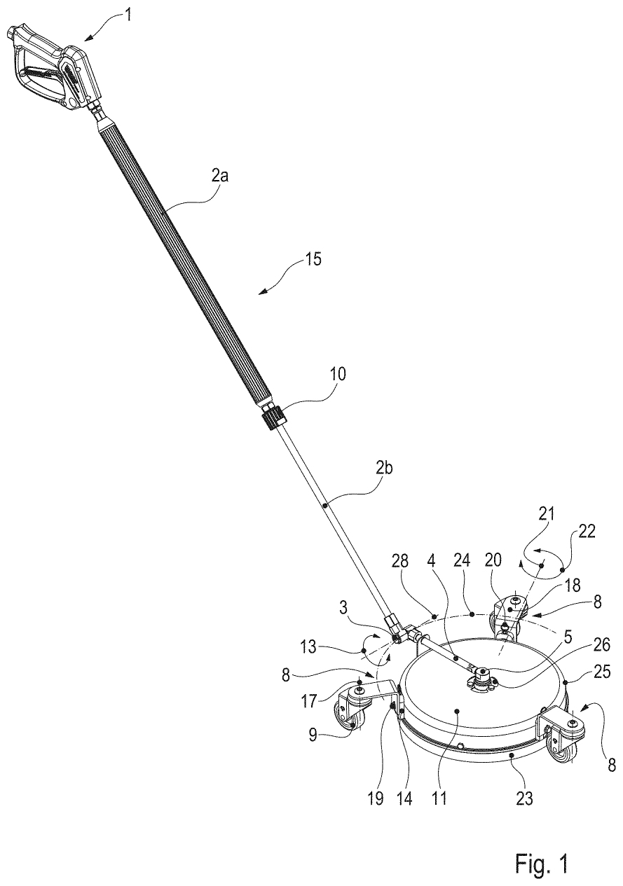

FIG. 1: is perspective illustration of a surface cleaner in the floor surface cleaning operating mode,

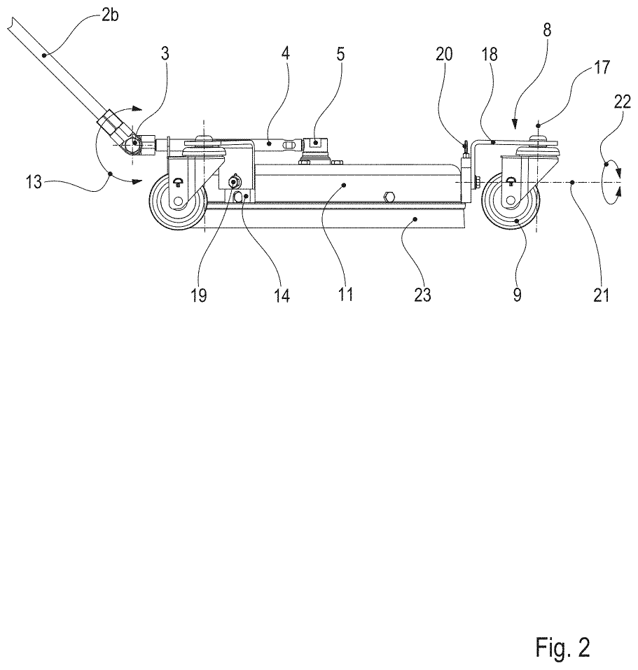

FIG. 2: is the same illustration as FIG. 1, in the underbody cleaning operating mode,

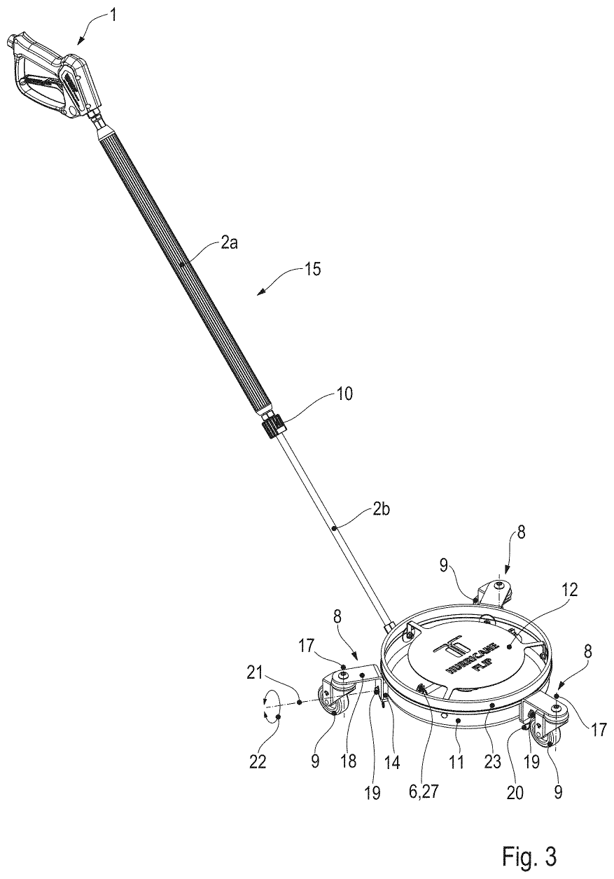

FIG. 3: is the surface cleaner in its working position, turned 180 degrees,

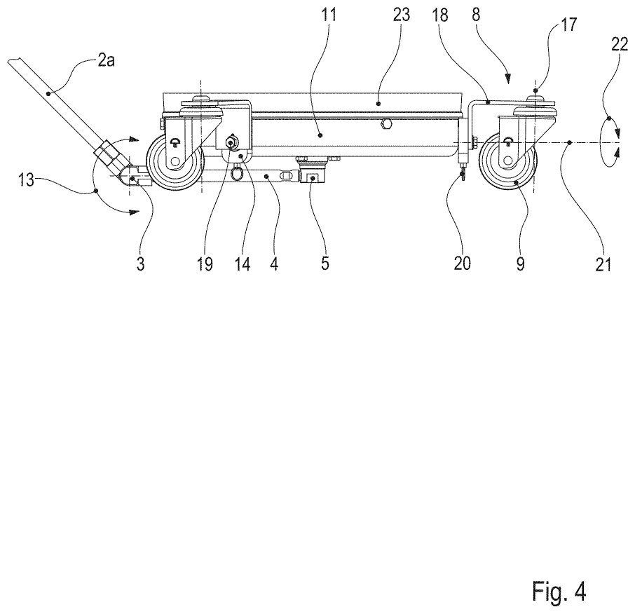

FIG. 4: is a side view of the surface cleaner in the working position according to FIG. 3, and

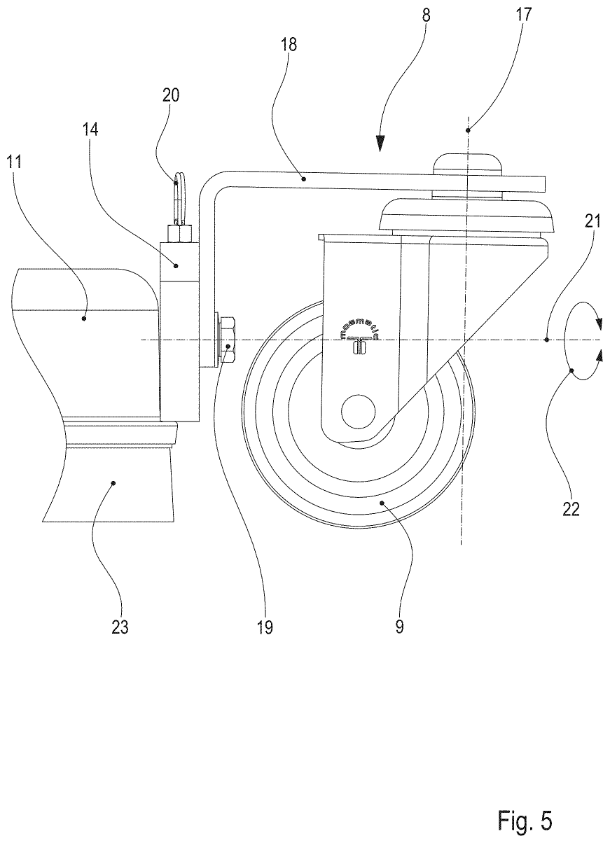

FIG. 5: is a detailed view of a chassis detail according to FIG. 1.

The surface cleaner shown in FIG. 1 preferably has a pot-shaped, cylindrical housing 11 that is open at the bottom. It is pushed by hand over a cleaning surface; in FIG. 1, the cleaning surface over which the surface cleaner is pushed is the floor. The cleaning surface is not shown in FIG. 2 because it is above the housing 11 which is open at its top.

A push rod 15 is used for manually moving the surface cleaner in both cleaning modes. In the preferred embodiment, the push rod 15 of the surface cleaner consists of an upper high-pressure gun 1 with a suitable actuating handle, which is connected to an upper lance part 2a in a fluid-tight manner via a first screw connection.

On the underside of the upper lance part 2a is a quick screw connection 10, in which the upper end of a lower lance part 2b is received, which in turn leads with its lower end via a screw connection into an articulation joint 3 of the housing, which is preferably able to swivel over an angular range of 180° or less about a horizontal swivel axis 28. The swivel angle in the direction of arrow 13 can be 180° or less in this case.

Instead of the design of the push rod 15 composed of the high-pressure gun 1 and the lance 2a, 2b attached to it, the push rod 15 can also consist of a tube, at the upper end of which the high-pressure gun 1 is arranged, which is connected to the articulation joint 3 via a high-pressure hose that is guided along the outside or inside of the tube.

Proceeding from the articulation joint 2, the high-pressure medium flows via a further screw connection into an approximately horizontally oriented connecting tube 4, which is fastened to the outer circumference of the housing 11 with the aid of a cross member, and thus the high-pressure medium is guided to the central swivel joint 5.

A rotor arm 6 is rotatably mounted on the central swivel joint 5 in the interior of the housing 11. The swivel joint 5 guides the high-pressure medium to the rotor arm, and in the process must absorb the relatively high axial forces during use both in the surface cleaning mode and in the underbody cleaning mode.

The housing 11 is essentially cylindrical and pot-shaped, and is closed on the edge by an approximately circumferential brush ring 23.

The high-pressure medium, which is supplied through the swivel joint 5, therefore acts directly on the rotor arm 6 and the cleaning nozzles 27, which are directed downwards at an angle at the free end of the rotor arm, and which are supported during high-pressure operation with their spray jets at an angle to the cleaning surface, thereby driving the rotor arm 6 to rotate.

A chassis is arranged on the outer circumference of the housing 11 of the surface cleaner, which in the embodiment shown consists of three swivel units 8 evenly distributed around the circumference, each swivel unit being designed to be swivelable by 180° about a horizontal swivel axis 21 in the direction of the arrow 22. A detailed view of the swivel mount of a castor 9 can be seen in FIG. 5.

According to FIG. 5, each swivel unit has a castor 9 which is rotatably mounted in a bearing bracket which is received in a vertical swivel axis 17 at the end of an angled cross member 18.

The other end of the angled cross member 18 is angled as a vertical limb through which the swivel joint 19, which is received in a locking housing 14, extends. The locking housing 14 is fixed to the outer circumference of the housing 11.

A spring-loaded locking pin 20 is arranged in the locking housing 14 and acts with its spring-loaded, bolt-side end on a locking groove in a swivel shaft of the swivel joint 19. When the locking pin 20 is engaged, the swivel joint 19 is blocked with the force of a spring (not shown). If, on the other hand, the locking pin 20 is pulled against its spring force, the swivel unit 8 can be swiveled in the swivel axis 21 by 180° in the direction of the arrow 22.

Decisive for the ability of the housing 11 of the surface cleaner to turn over is the fact that the articulation joint 3 for the inlet of the high-pressure medium has been relocated laterally outside the outer circumference (circumferential circle 25) of the housing 11, so that the housing can be turned by 180°. This can be seen in particular in FIG. 4. In FIG. 4, it can be seen that when the surface cleaner is turned over into its second working position shown in FIGS. 3 and 4, the articulation joint 3 comes close to the floor, and the circumferential brush ring 23 is the uppermost part of the surface cleaner.

Accordingly, the articulation joint 3 lies in the region of an outer circle 24, the radius of which is greater than the circumferential circle 25 of the housing 11.

The radius of the outer circle 24 should preferably not be greater than the outer circumference formed by the swivel unit 8. This results in a space-saving structure because the articulation joint does not protrude beyond the outer diameter of the chassis formed by the castors.

However, it can also be provided that the radius of the outer circle 24 projects beyond the outer radius of the swivel unit 8. This is shown in FIG. 4 as a further preferred embodiment. It is also preferred if the constructed height of the chassis 8, 9, 14, 18, 19 does not protrude beyond the constructed height of the cylindrical, pot- shaped housing 11 of the surface cleaner. This means that the surface cleaner can also be pushed into narrow, slot-shaped surfaces to be cleaned, such as those found in the filter plates of a plate filter.

FIG. 1 also shows an outlet opening 26 approximately in the middle region of the housing 11, which performs a function in the second operating mode according to FIG. 2. This will be explained later.

If an underbody cleaning takes place with the transition from FIGS. 1 and 2 to FIGS. 3 and 4, the given locking pin 20 is pulled back on the swivel unit 8 according to FIG. 5, and then the angled cross member 18 swivels about the swivel axis 21 in the direction of the arrow 22, and the locking pin 20 is released again, such that the swivel position of the swivel unit 8, 9 is locked in a position pivoted by 180 degrees, and assumes the swivel position according to FIGS. 3, 4 and 5.

In this underbody cleaning operation, it is provided in a preferred embodiment that the upper region of the housing 11 open at the top is at least partially covered at the top by a protective plate 12. The rotor arm 6 is thus largely covered, and only cleaning nozzles 27 in an outer circle outside the protective plate 12 are accessible and active. It is then no longer possible to grasp the rotor arm 6 itself.

At the same time, when the operating mode is changed, the articulation joint 3 is swiveled 180° or less, in order to achieve the swivel position according to FIG. 2.

During the process of turning over, it is therefore not necessary to loosen the screw connection on the articulation joint 3, because the high-pressure inlet is designed as a sealed articulation joint 3.

As already stated in the general description, the ability to turn the swivel unit 8, 9, 18 180 degrees is not necessary for the solution. It can be provided that the surface cleaner also works in the surface cleaning mode according to FIG. 1 with the orientation of the castors 9 shown in FIG. 2—specifically, with the castors swiveled upward, the position of which is actually intended for underbody operation—such that the castors 9 are no longer active, and do not have a supporting function on the floor-side cleaning surface. In this case, the castors 9 no longer roll on the surface to be cleaned, and the device is only pushed over the floor surface to be cleaned via the brush ring 23. It is clear from the foregoing that the ability to turn the swivel units by 180° is preferred, but is not absolutely necessary for the solution.

In the third described embodiment, the chassis 8, 9, 18 with the castors 9 can be completely omitted. In this case, sliding elements or runners (not shown in more detail) are then present on the upper side of the housing 11.

The advantage of the measure according to the invention which allows for the multiple use of such a surface cleaner is the minimal workload required for the transition from surface cleaning operation to underbody cleaning operation. Another advantage is the low constructed height, which is achieved by the special type of swivel units 8, 9, 18, which do not project beyond the height of the housing 11 in terms of their constructed height.

Another advantage is that the articulation joint 3 can be swiveled even when high pressure prevails, which means that it can be swiveled directly from one operating state to the other even when high pressure is applied to the surface cleaning device.

Another advantage is that the swivel units 8, 9, 18 can be swiveled without tools.

### LIST OF REFERENCE SIGNS

1 High-pressure gun

2 Upper lance part 2a; Lower lance part 2b

3 Articulation joint

4 Connecting tube

5 Swivel joint

6 Rotor arm

7

8 Swivel unit

9 Castor

10 Quick screw connection

11 Housing

12 Protective plate

13 Direction of arrow

14 Locking housing

15 Push rod

16

17 Swivel axis (vertical)

18 Angled cross member

19 Swivel joint

20 Locking pin

21 Swivel axis (horizontal)

22 Direction of arrow

23 Brush ring

24 Outer circle

25 Circumferential circle (housing 11)

26 Outlet opening

27 Cleaning nozzle

28 Swivel axis

1. A surface cleaner with a connection to a high-pressure medium, consisting of a pot-shaped housing (11) open on one side, in which at least one rotor arm (6) is rotatably mounted on a swivel joint (5) in the center of the housing, wherein one or more cleaning nozzles (27) are arranged on the rotor arm (6), which are connected in a fluid-conducting manner to the high-pressure medium guided through the swivel joint (5), wherein the housing (11) is designed to be able to turn 180 degrees for a second operating mode, wherein the surface cleaner can be operated in the at least two different operating modes, wherein the first operating mode consists of a surface cleaning operation with the housing (11) and the cleaning nozzles (27) arranged therein pointing downwards toward a floor, and wherein the second operating mode is designed as a cleaning operation in which the housing (11), turned over 180 degrees with the cleaning nozzles (27) pointing upwards, is directed toward a cleaning surface arranged at a distance from the floor, characterized hi that the surface cleaner has a chassis (8, 9, 17) for supporting the housing (11) in the first and second operating positions relative to the floor surface.

2. The surface cleaner according to claim 1, characterized hi that the chassis consists of individual castors (9) which are uniformly distributed around the circumference of the housing (11) in a horizontal swivel axis (21) in a manner allowing swiveling 180 degrees, and locking.

3. The surface cleaner according to any one of claim 1 or 2, characterized in that each castor (9) forms a swivel unit (8) which is pivotably mounted via a vertical swivel axis (17) at one end of a horizontal angled cross member (18), in that the other end of the angled cross member (18) is bent by 90 degrees and received in a horizontal swivel axis of a swivel joint (19) of the housing, and in that each of the swivel positions of the swivel joint (19) can be locked by a spring-loaded locking pin (20).

4. A surface cleaner with a connection to a high-pressure medium, consisting of a pot-shaped housing (11) open on one side, in which at least one rotor arm (6) is rotatably mounted on a swivel joint (5) in the center of the housing, wherein one or more cleaning nozzles (27) are arranged on the rotor arm (6), which are connected in a fluid-conducting manner to the high-pressure medium guided through the swivel joint (5), wherein the housing (11) is designed to be able to turn 180 degrees for a second operating mode, wherein the surface cleaner can be operated in the at least two different operating modes, wherein the first operating mode consists of a surface cleaning operation with the housing (11) and the cleaning nozzles (27) arranged therein pointing downwards toward a floor, and wherein the second operating mode is designed as a cleaning operation in which the housing (11), turned over 180 degrees with the cleaning nozzles (27) pointing upwards, is directed toward a cleaning surface arranged at a distance from the floor, characterized hi that the surface cleaner has two separate chassis for supporting the housing (11) in the first and second operating positions relative to the floor surface.

5. The surface cleaner according to claim 5, characterized in that the surface cleaner has a first chassis (8, 9, 17) only for supporting the housing (11) in the first operating position relative to the floor surface, and in that a second chassis (8, 9, 17) is present only for supporting the housing (11) in the second operating position relative to the floor surface.

6. The surface cleaner according to any one of claims 1 to 5, characterized hi that the high-pressure medium is guided via a manually operated push rod (15) into an articulation joint (3) attached to the side of the housing (11) of the surface cleaner.

7. The surface cleaner according to any one of claims 1 to 6, characterized hi that the surface cleaner can be operated in a third operating mode when the housing (11) is turned only 90 degrees from its first or second operating position.

8. The surface cleaner according to any one of claims 1 to 7, characterized in that, in order to reduce the constructed height of the surface cleaner, the high-pressure medium is introduced into the swivel joint (5) in the center of the housing via a connecting tube (4) attached to the side of the swivel joint (5), which is connected to the articulation joint (3) in a fluid-conducting manner.

9. The surface cleaner according to any one of claims 1 to 8, characterized hi that the push rod (15) of the surface cleaner is formed by a hand-operated high-pressure gun (1) which is connected to a high-pressure lance (2a, 2b) in a fluid-conducting manner.

10. The surface cleaner according to claim 9, characterized in that the high- pressure lance (2) consists of two lance parts (2a, 2b) screwed together, and in that the lower lance part (2b) is screwed to the articulation joint (3) of the housing in a sealed manner.

11. The surface cleaner according to any one of claims 1 to 10, characterized in that a protective plate (12) which partially covers the rotor arm (6) and leaves the cleaning nozzles (27) uncovered is arranged in the interior of the housing (11).

12. The surface cleaner according to any one of claims 1 to 11, characterized in that one or more outlet openings (26) are arranged in the cover region of the housing (11).

13. The surface cleaner according to any one of claims 1 to 12, characterized in that the surface cleaner has a low constructed height in order to be able to clean surfaces that are close together and that are opposite to each other at an angle of 180 degrees.

14. The surface cleaner according to any one of claims 1 to 13, characterized in that, in order to switch between the two operating modes, the housing (11) is turned from one flat side by 180° to the opposite flat side.

15. The surface cleaner according to any one of claims 1 to 14, characterized in that the housing (11) with the chassis (8, 9) has a low constructed height, such that it is possible to expediently carry out an underbody cleaning even with little floor clearance of underbodies or other cleaning surfaces to be cleaned.
